(19) United States
(12) Patent Application Publication
(10) Pub. No.: US 2008/0171171 A1
(43) Pub. Date: Jul. 17, 2008

(54) Handcraft guiding tool

(75) Inventor: Junichi Kuwabara, Osaka (JP)

Correspondence Address: HAMRE, SCHUMANN, MUELLER & LARSON, P.C., P.O. BOX 2902, MINNEAPOLIS, MN, 55402-0902, US

(73) Assignee: CLOVER MFG. CO., LTD., Osaka-shi (JP)

(21) Appl. No.: 12/009,298

(22) Filed: Jan. 17, 2008

(30) Foreign Application Priority Data
Jan. 17, 2007 (JP) 2007-007720

(51) Int. Cl. B32B 33/00

(52) U.S. Cl. 428/41.8

(57) ABSTRACT

A handcraft guiding tool includes a sticker attached to fabric, and needlework indication provided at the sticker. The needlework indication is made up of at least one unit group to which a series of sets belong. Each of the sets includes a mark and a numeral adjacent to the mark. The mark indicates a position and a direction in which the needle is to be brought through the fabric. The numeral indicates the order of passing the needle through the fabric.

### BACKGROUND OF THE INVENTION

1. Field of the Invention

The present invention relates to a handcraft guiding tool suitably used in the field of craftwork, in particular, embroidery such as smocking.

2. Description of the Related Art

Smocking is one of the known embroidery techniques used for providing a decorative effect. Generally, in smocking, a piece of flat fabric is gathered to create a number of small folds, with these folds threaded with floss to make various kinds of designs. According to the conventional method of smocking, for example, a pattern is firstly generated on a sheet of paper and then transferred onto fabric using chalk paper or the like. With the transferred pattern as the marking of positions, sewing is carried out according to the stitching order indicated in a manual. According to another conventional method, fine and accurate running stitches are used to gather a large number of small pleats, and then sewing is carried out referring to a manual.

The smocking process, however, is rather tricky. Particularly, it requires preparations including pattern transfer as well as pleating with running stitches. Further, it is difficult to follow the order of bringing the needle up and down through the fabric by referring to the transferred pattern on the fabric. When the fabric to be used is provided with a certain pattern (for example, checked gingham), it is possible to make running stitches by using the grid pattern as a reference to produce pleats. In this fashion, it is unnecessary to transfer a design pattern onto the fabric, but one still has to think about the order of stitching referring to a manual. Furthermore there are only limited designs of fabric applicable to this method, thereby making it difficult to create a piece of work to one's taste. The intervals of the stitches are restricted by the size of the design of the fabric.

JP-U-H05-31780, for example, teaches a guide tape for guiding hand-sewing work. The guide tape disclosed in this document, however, is rather simple, only provided with graduations at regular intervals. Such a guide tape may be convenient for doing simple hand-sewing work such as running stitches, but not be usable for complicated hand-sewing work such as smocking, in which much attention should be paid to the positions and order of bringing the needle up and down through the fabric.

### SUMMARY OF THE INVENTION

The present invention has been proposed in view of the foregoing circumstances. It is an object of the present invention to provide a handcraft guiding tool configured to facilitate the hand-sewing work, such as smocking, which is conventionally a rather complicated procedure.

According to the present invention, there is provided a handcraft guiding tool that includes a sticker attached to fabric, and needlework indication provided at the sticker. The needlework indication comprises at least one unit group including a series of sets, and each of the sets comprises a mark and a numeral adjacent to the mark, where the mark indicates a position and a direction in which the needle is to be brought through the fabric, while the numeral indicates the order of passing the needle through the fabric.

With the above arrangement, even when one needs to perform hand-sewing work of a complicated procedure such as smocking, appropriate guiding for the hand-sewing work is readily obtained, thereby improving efficiency of the hand-sewing work.

Preferably, the sticker may include a first surface and a second surface opposite to the first surface, where the first surface has an adhesive applied thereto for adhesion to the fabric.

Preferably, the needlework indication may be exposed at the second surface of the sticker.

With the above configuration, when the first surface of the sticker is attached to the fabric via the adhesive, the needlework indication formed and exposed on the second surface appears on the front surface of the sticker, which is advantageous to making the indication readily visible.

Preferably, the handcraft guiding tool of the present invention may further comprise a release sheet and a transparent film, where the release sheet is attached to the first surface of the sticker, and the transparent film is attached to the second surface of the sticker via an additional adhesive.

With the above arrangements, in use of the guiding tool, the transparent film with the sticker is attached thereto is firstly peeled off from the release sheet, and then the transparent film carrying the sticker is attached to the target region of the fabric. Thereafter, the transparent film is peeled off, leaving the sticker attached to the fabric. In this manner, it is possible to prevent the adhesive applied to a surface of the sticker from being stuck to somewhere other than the intended place, which improves usability of the guiding tool.

Preferably, the sticker may comprise a plurality of unit sheet pieces spaced from each other, wherein the mark of each set is arranged to point to a position between neighboring ones of the unit sheet pieces.

According to the above arrangements, the separate unit sheet pieces can provide the following advantages. In the portion of the fabric where the unit sheet piece is provided, the stiffness of the unit sheet piece itself makes the portion stiff and hard to bend, whereas in the portion of the fabric between the unit sheet pieces (i.e., in the portion of the fabric where the unit sheet piece is not provided), the fabric is relatively bendable, and thus, a pleat is readily formed in the portion between the unit sheet pieces. Further, the positions where the needle is to be brought through are set in the portions between the unit sheet pieces, and accordingly, it is readily possible to gather pleats simply by pulling the thread after drawing the needle through. As such, the above configuration facilitates the sewing work in the smocking.

Preferably, the additional adhesive may be weaker in adhesion than the adhesive on the first surface.

With the above arrangement, when peeling off the transparent film after attaching the sticker to the fabric, it is possible to prevent the sticker from being peeled off from the fabric together with the transparent film.

Preferably, the sticker may be made of a water-soluble material.

With the above arrangement, after the hand-sewing work is carried out with the sticker stuck to the fabric, the fabric may be washed with water to cause the sticker to dissolve in water and thus to be washed away. In this manner, the removal of the sticker from the fabric can be easily performed.

The other features and advantages of the present invention will become more apparent from the following detailed description when taken in conjunction with the accompanying drawings.

### BRIEF DESCRIPTION OF THE DRAWINGS

FIG. 1 is a plan view showing an example of a handcraft guiding tool according to the present invention;

FIG. 2 is an enlarged sectional view taken along the line II-II in FIG. 1;

FIG. 3 is a plan view showing a step of a method of using the guiding tool shown in FIG. 1;

FIG. 4 is a plan view showing a step following the one shown in FIG. 3;

FIG. 5 is a plan view showing a step following the one shown in FIG. 4;

FIG. 6 is a plan view showing a step following the one shown in FIG. 5;

FIG. 7 is a plan view showing a step of a method of using a guiding tool according to the present invention;

FIG. 8 is a plan view showing a step following the one shown in FIG. 7;

FIG. 9 shows a method of manufacturing a handcraft guiding tool according to the present invention; and

FIG. 10 shows other examples of handcraft guiding tool according to the present invention.

### DETAILED DESCRIPTION OF THE PREFERRED EMBODIMENTS

Preferred embodiments of the present invention will be described below with reference to the drawings.

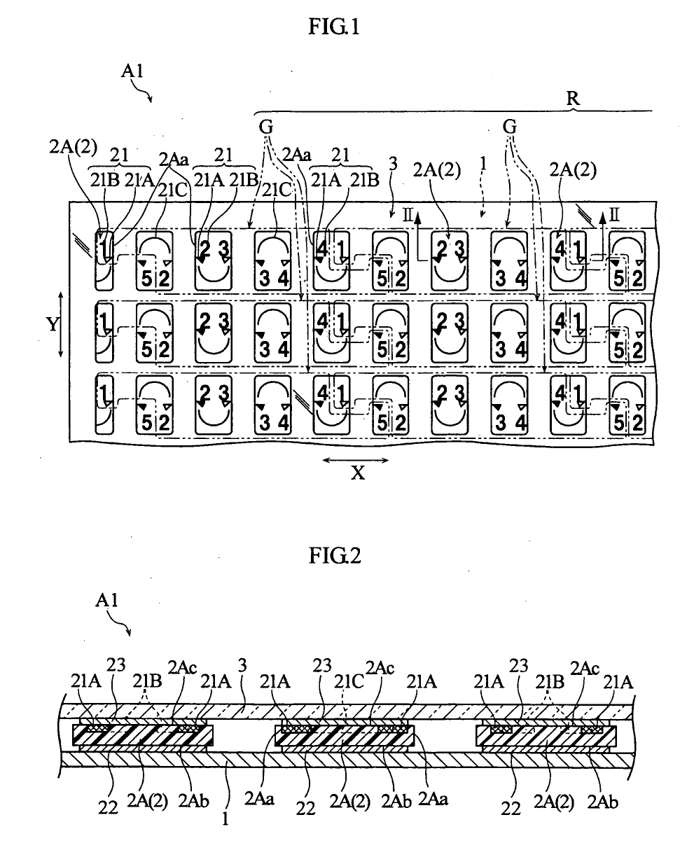

FIG. 1 shows an example of a handcraft guiding tool according to the present invention. FIG. 2 is an enlarged cross sectional view taken along the line II-II in FIG. 1. As shown in FIGS. 1 and 2, the guiding tool A1 of the present embodiment includes a release sheet 1, a sticker 2 and a transparent film 3, which are laid one on another to collectively form a rectangular, sheet-shaped structure as viewed in plan. The guiding tool A1 is used, in doing sewing work such as smocking, for indicating positions where a needle is to be brought through the fabric.

The release sheet 1 has an inner surface facing the sticker 2. This inner surface is pretreated so that an adhesive object attached thereto can be easily peeled off. To this end, for example, a silicone resin may be applied to the inner surface.

In the illustrated example, the sticker 2 is made up of a plurality of unit sheet pieces 2A of a rectangular shape separate from each other. The unit sheet pieces 2A are arranged linearly in the direction indicated by an arrow X at prescribed intervals. Each unit sheet piece 2A is provided with non-numeral marks 21A, 21C and numerals 21B.

The mark 21A is for indicating where and in which direction the needle is to be brought through the fabric in hand-sewing work. In the present embodiment, the mark 21A has a triangular shape, and is provided adjacent to an edge 2Aa in the arrow X direction of each unit sheet piece 2A. The mark 21A has a tip end as a vertex of the triangular shape pointing the edge 2Aa, indicating that the needle is to be brought through the fabric near the tip end corresponding to the vertex (in the portion between two neighboring unit sheet pieces 2A). Further, in the present embodiment, the mark 21A indicating an exiting position (i.e., the position where the needle is caused to pass through the fabric from the back or wrong side to the front or right side of the fabric) is a solid-white triangle, whereas the mark 21A indicating an entering position (i.e., the position where the needle is to be brought from the front to the back of the fabric) is a solid-black triangle. This color difference of the mark 21A serves to differentiate the direction in which the needle is to pass through the fabric.

The numeral 21B is provided near the mark 21A, one for one, to indicate the order of bringing the needle through the fabric at the position indicated by the corresponding mark 21A.

The mark 21C, to be described later in detail, is provided across the mark 21A indicating the position where the needle is to be brought out through the fabric and the mark 21A indicating the position where the needle is to be thrust in consecutively, thereby showing the shape to be formed by the thread after the needle is brought up and down through the fabric. As shown in FIG. 2, the marks 21A, 21C and the numerals 21B are formed to be exposed on the upper surface (surface 2Ac) of each unit sheet piece 2A.

The mark 21A having the above configuration and the numeral 21B corresponding thereto constitute a set 21. A plurality of sets 21 provided across a plurality of unit sheet pieces 2A constitute a group G according to a prescribed rule (within the range delimited by a phantom line). In the present embodiment, a plurality of unit sheet pieces 2A are provided such that a plurality of groups G are systematically arranged lengthwise and crosswise (in the arrow X direction and the arrow Y direction perpendicular to the X direction). The groups G as a whole constitute needlework indication R.

Each unit sheet piece 2A has a lower surface (surface 2Ab) applied with an adhesive 22 having certain adhesion. The adhesive 22 is provided in a region of a size smaller than the size of the unit sheet piece 2A, as viewed in plan. Each unit sheet piece 2A has an upper surface (surface 2Ac) provided with an adhesive 23 having certain adhesion. The adhesive 23 is provided in a region of a size smaller than the size of the unit sheet piece 2A, as viewed in plan. The adhesive 23 is weaker in adhesion than the adhesive 22.

The transparent film 3 is formed of a transparent resin, and attached to the surface 2Ac via the adhesive 23.

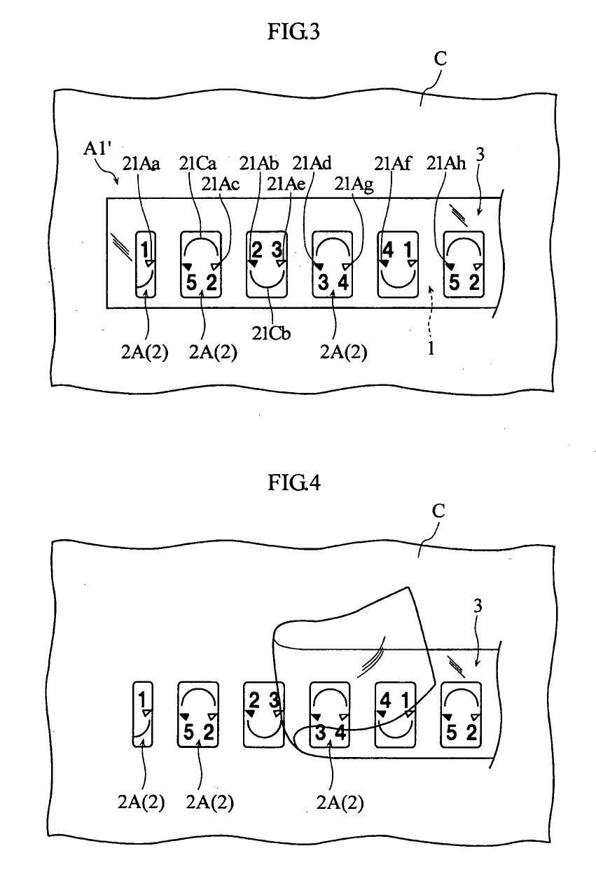

Hereinafter, a method of performing smocking using the guiding tool A1 will be explained with reference to FIGS. 3-8. It is noted that the guiding tool A1 of the present embodiment is for producing a smocking design called “cable smocking”.

Firstly, a flat fabric C is prepared as an object of the smocking. From the guiding tool A1, a strip piece A1′ of a shape corresponding to an area to be provided with the smocking is cut off (see FIG. 3). Next, the transparent film 3 of the strip piece A1′ is pinched at its end portion to peel off the transparent film 3 together with the sticker 2 (a plurality of unit sheet pieces 2A) from the release sheet 1, to cause the adhesive 22 to be exposed on the surface. Subsequently, the transparent film 3 and the plurality of unit sheet pieces 2A are placed and pressed onto a predetermined area of the fabric C and, then, the transparent film 3 is peeled off so that only the unit sheet pieces 2A are stuck to the fabric C via the adhesive 22 (see FIG. 4). The adhesive 23 provided between the transparent film 3 and the unit sheet pieces 2A is weaker in adhesion than the adhesive 22 provided between the fabric C and the unit sheet pieces 2A, which advantageously prevents the unit sheet pieces 2A from being peeled off from the fabric C together with the transparent film 3 when peeling off the transparent film 3.

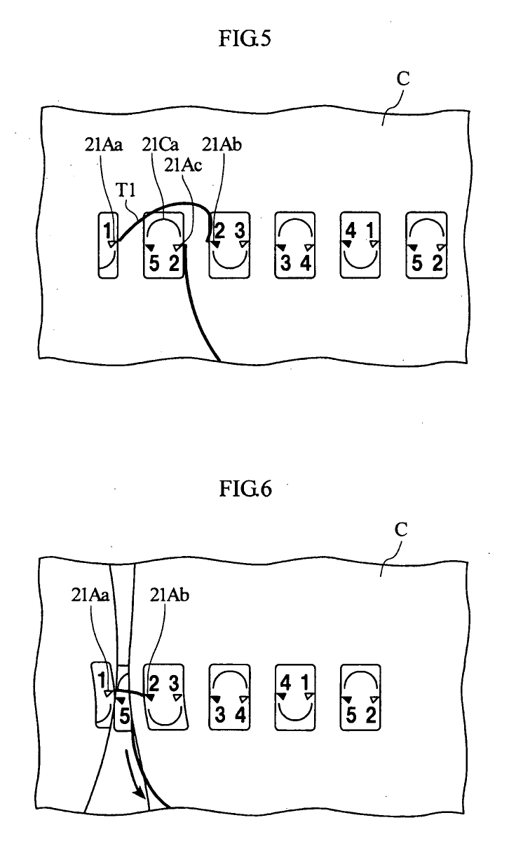

Then, the smocking is performed by following the needlework indication on the sticker 2. Specifically, with a thread knotted on one end, a threaded needle is brought out through the fabric at the position indicated by a white mark 21Aa corresponding to the numeral “1”. Then, the needle is thrust in at the position indicated by a black mark 21Ab corresponding to the numeral “2”, and the needle is brought out at the position indicated by a white mark 21Ac corresponding to the numeral “2” (see FIG. 5). When bringing the needle out at the position indicated by the mark 21Ac, the thread T1 positioned across the mark 21Aa and the mark 21Ab is made to follow the shape of a mark 21Ca provided across the marks 21Aa and 21Ab. Since the mark 21Ca is of a U shape that opens downward in the figure, the thread T1 is positioned on the upper side in the figure with respect to the needle brought out at the position indicated by the mark 21Ac. When the needle is brought out at the position indicated by the mark 21Ac, the thread is pulled downward in the figure for pleating, as shown in FIG. 6.

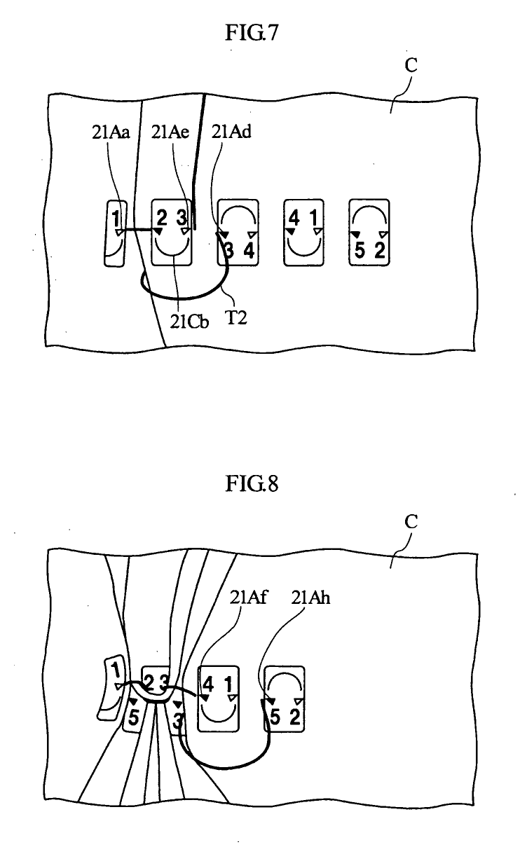

Then, as shown in FIG. 7, the needle is thrust in at the position indicated by a black mark 21Ad corresponding to the numeral “3”, and is brought out at the position indicated by a white mark 21Ae corresponding to the numeral “3”. When bringing the needle out at the position indicated by the mark 21Ae, the thread T2 across the mark 21Ac (not shown in FIG. 7; see FIG. 3) and the mark 21Ad is made to follow the shape of a mark 21Cb provided across the marks 21Ac and 21Ad. That is, since the mark 21Cb is of a U shape that opens upward in the figure, the thread T2 is positioned on the lower side in the figure with respect to the needle brought out at the position indicated by the mark 21Ae. When the needle is brought out at the position indicated by the mark 21Ae, the thread is pulled upward in the figure for pleating.

Then, as shown in FIG. 8, the needle is thrust in at the position indicated by a black mark 21Af corresponding to the numeral “4”, and then brought out at the position indicated by a white mark 21Ag corresponding to the numeral “4” (not shown in FIG. 8; see FIG. 3), and the thread brought out at the mark 21Ag is pulled downward in the figure to gather a pleat. Further, the needle is thrust in at the position indicated by a black mark 21Ah corresponding to the numeral “5”, which completes the stitching for the unit design. Thereafter, the needle is repeatedly brought up and down according to the above-described procedure to make the unit designs successively in accordance with the smocking design to be produced, and lastly, the thread is knotted on the wrong side of the fabric C. The unit sheet pieces 2A stuck to the fabric C are removed to complete the work. It is noted that the unit sheet pieces 2A may be removed during the sewing work sequentially, by removing a respective unit sheet piece 2A once the needle is brought through every position indicated by the mark 21A provided thereon.

As described above, when using the guiding tool A1, even in the case of performing hand-sewing work with relatively complicated procedure such as the smocking, it is possible to guide the hand-sewing work properly, thereby improving efficiency of the hand-sewing work.

Further, the guiding tool A1 is formed such that the sticker 2 is sandwiched between the release sheet 1 and the transparent film 3. Thus, in use of the guiding tool A1, it is only necessary to peel off the release sheet 1 before the sticker 2 is to be stuck to the fabric C. This arrangement advantageously prevents the adhesive 23 applied to the surface of the sticker 2 from being undesirably adhered to a site other than the fabric C.

Furthermore, when performing the smocking using the guiding tool A1, in the area of the fabric C where the unit sheet pieces 2A are provided, the stiffness of the unit sheet pieces 2A themselves provides the fabric C with stiffness, making it hard to bend. Meanwhile, in the area of the fabric C between the neighboring unit sheet pieces 2A (not provided with the unit sheet pieces 2A), the fabric C is relatively bendable, making it easy to form the pleats in the areas between the neighboring unit sheet pieces 2A. Moreover, the positions where the needle is to be brought through the fabric are set in the portions between the unit sheet pieces 2A, and thus, it is readily possible to gather pleats by pulling the thread after drawing the needle through the fabric. Accordingly, the use of the guiding tool A1 according to the present embodiment facilitates the sewing work in the smocking.

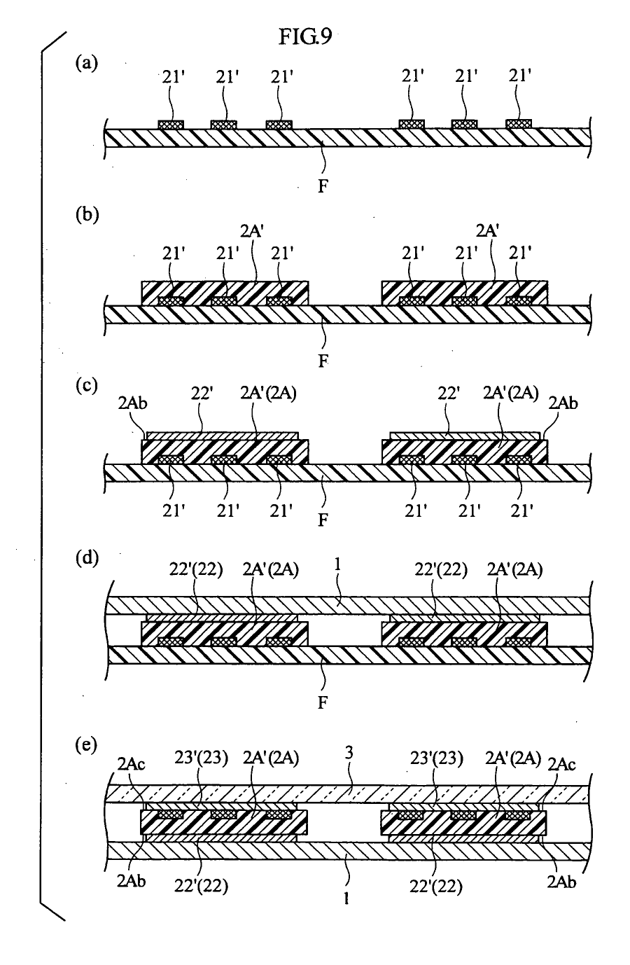

An example of a method for manufacturing the guiding tool A1 described above will be explained with reference to FIG. 9(a)-(e).

Firstly, as shown in FIG. 9(a), a releasable film F is prepared, and an ink layer 21′ is formed in a predetermined area on the releasable film F. The ink layer 21′ is to be the marks 21A, 21C and the numerals 21B. To form the ink layer 21′, offset printing or silk-screen printing may be performed using an ink material of a predetermined color, for example. Next, as shown in FIG. 9(b), a resin layer 2A′ is formed in a predetermined area on the releasable film F. The resin layer 2A′, which is to be the unit sheet pieces 2A, is formed to cover the ink layer 21′. The resin layer 2A′ may be formed by silk-screen printing using an epoxy resin, for example. Then, as shown in FIG. 9(c), an adhesive layer 22′ (for application of the adhesive 22) is formed on a surface 2Ab of the resin layer 2A′. To form the adhesive layer 22′, silk-screen printing, for example, is performed. Then, as shown in FIG. 9(d), the release sheet 1 is attached onto the adhesive layer 22′. Next, as shown in FIG. 9(e), after removing the releasable film F, an adhesive layer 23′ (for application of the adhesive 23) is formed on a front surface (surface 2Ac) of the resin layer 2A′ exposed by removal of the film F, in a similar manner as in the formation of the adhesive layer 22′. The transparent film 3 is then attached onto the adhesive layer 23′. The guiding tool A1 of a sheet shape is obtained in this manner.

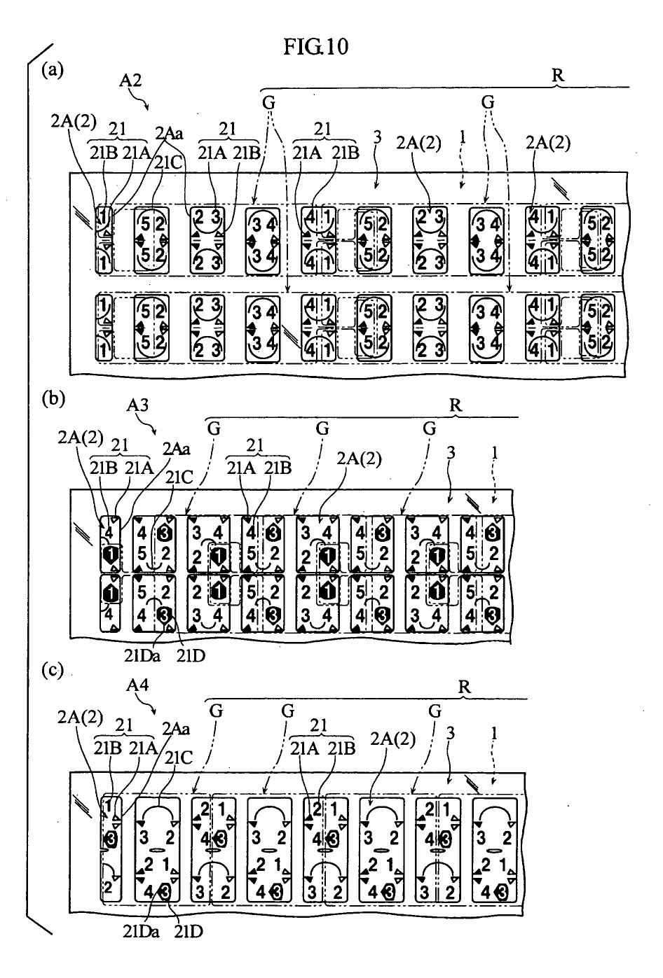

FIG. 10(a)-(c) shows other examples of the handcraft guiding tool according to the present invention. In this figure, the same or like elements as those in the above embodiment are denoted by the like reference characters, and description thereof will not be repeated where appropriate.

The illustrated guiding tools A2-A4 differ from the guiding tool A1 of the above embodiment in pattern of the indication R provided on the unit sheet pieces 2A. Specifically, the guiding tools A2 through A4 are for producing designs different from the one produced by using the guiding tool A1. The guiding tool A2 shown in FIG. 10(a) is for forming a smocking design called “double cable smocking”, in which the design that can be produced by the above-described handcraft guiding tool A1 is formed in two rows axisymmetrically in the vertical direction. When performing the smocking using the guiding tool A2, the embroidery is firstly done for the upper row, and then the embroidery of the lower row will follow. The specific procedure of the sewing work is similar to that described above in conjunction with the guiding tool A1 of the above embodiment.

The guiding tools A3 and A4 are for forming the smocking designs called “diamond smocking” and “honeycomb smocking”, respectively, each having two rows in the vertical direction. In the guiding tools A3 and A4, marks 21D are additionally provided corresponding to certain numerals 21B. The mark 21D is of a shape having an end 21Da projecting in one direction, and is superposed on the corresponding numeral 21B, with the numeral 21B shown in outline. The mark 21D is provided only for the position where it is necessary to pull the thread after drawing the needle all the way through the fabric C, and the projecting end 21Da of the mark 21D indicates the pulling direction of the thread. When performing the smocking using a respective one of the guiding tools A3 and A4, the embroidery is firstly finished for the upper row, which is followed by the embroidery of the lower row. As to the specific procedure of the sewing work, while the positions and directions for bringing the needle through the fabric as well as the stitching order are similar to those described above in conjunction with the guiding tool A1 of the above embodiment, the timing of pulling the thread after bringing the needle out differs from the case of the guiding tool A1. Specifically, in use of the guiding tool A1 of the above embodiment, the thread is pulled to gather a pleat every time the needle is brought up through the fabric C. In contrast, in use of each of the guiding tools A3 and A4, the thread is pulled for pleating only after the needle is brought out at the position corresponding to the outlined numeral 21B. In this manner, the guiding tool of the present invention may be adapted to production of many variations of designs.

While the specific embodiments of the present invention have been explained above, the present invention is not limited thereto, and various modifications are possible.

For example, the sticker (i.e., the respective unit sheet pieces) may be made of a water-soluble material such as a water-soluble cellulose derivative. In this instance, the fabric with the sticker attached may be washed in water after completion of the hand-sewing work. As a result, the clinging sticker dissolves in water and is washed away. In this manner, the sticker of a water-soluble material simplifies the removal of the sticker from the fabric.

Alternatively, the needlework indication itself may be made of a transferable and water-soluble material. In this case, the indication also serves as a sticker which may be formed on a transparent film by printing, for example. In use of such a guiding tool, the fabric with the indication (or sticker) transferred thereto may be washed in water after completion of the hand-sewing work, thereby washing away the indication.

1. A handcraft guiding tool comprising:
a sticker attached to fabric; and
needlework indication provided at the sticker;
wherein the needlework indication comprises at least one unit group including a series of sets, wherein each of the sets comprises a mark and a numeral adjacent to the mark, the mark indicating a position and a direction in which the needle is to be brought through the fabric, the numeral indicating an order of passing the needle through the fabric.

2. The handcraft guiding tool according to claim 1, wherein the sticker includes a first surface and a second surface opposite to the first surface, the first surface having an adhesive applied thereto for adhesion to the fabric.

3. The handcraft guiding tool according to claim 2, wherein the needlework indication is exposed at the second surface of the sticker.

4. The handcraft guiding tool according to claim 2, further comprising a release sheet and a transparent film, the release sheet being attached to the first surface of the sticker, the transparent film being attached to the second surface of the sticker via an additional adhesive.

5. The handcraft guiding tool according to claim 4, wherein the sticker comprises a plurality of unit sheet pieces spaced from each other, wherein the mark of each set is arranged to point to a position between neighboring ones of the unit sheet pieces.

6. The handcraft guiding tool according to claim 4, wherein the additional adhesive is weaker in adhesion than the adhesive on the first surface.

7. The handcraft guiding tool according to claim 1, wherein the sticker is made of a water-soluble material.
